(19) United States
(12) Patent Application Publication
(10) Pub. No.: US 2025/0062700 A1
(43) Pub. Date: Feb. 20, 2025

(54) SYNTHETIC CURRENT COMPENSATION IN SWITCHED POWER CONVERTERS

(71) Applicant: TEXAS INSTRUMENTS INCORPORATED, Dallas, TX (US)

(72) Inventors: Mohamed Ahmed, Merrimack, NH (US); Matthew Schurmann, Wylie, TX (US); Preetam Tadeparthy, Bangalore (IN); Rohit Narula, Bangalore (IN); Vikram Gakhar, Bangalore (IN); Vikas Lakhanpal, Bilaspur (IN); Karthik Anyam, Bangalore (IN); Rengang Chen, Center Valley, PA (US)

(21) Appl. No.: 18/451,363

(22) Filed: Aug. 17, 2023

(51) Int. Cl. H02M 7/537

(52) U.S. Cl. CPC H02M 7/537

(57) ABSTRACT

A power controller comprises a control loop configured to control timing of pulsed signals that activate phases of a coupled inductor voltage regulator based on current demand of a load circuit and comprises a transient detection circuit configured to determine a projected current through a compensation inductor of the coupled inductor voltage regulator based on a state of the phases and operating parameters of the coupled inductor voltage regulator. The transient detection circuit is configured to detect a transient in the current demand of the load circuit based on a variability in phase-to-phase overlap of the pulsed signals. Responsive to detecting the transient, the transient detection circuit is configured to apply a correction to the control loop that alters the timing of the pulsed signals based on the projected current through the compensation inductor.

### TECHNICAL FIELD

Embodiments of this disclosure relate to voltage regulators and, more particularly, to current emulation in a multi-phase switched power converter topology.

### BACKGROUND

In power-hungry applications such as cloud computing and artificial intelligence, the need for powerful microprocessors is sought. These processors can have stringent transient needs with high current slew rates higher than 3000 A/us, for example. Multi-phase buck converter designs can be utilized to design power supplies toward the requested power requirements. Because board design can lead to dense board construction to accommodate the power requirements, the addition of more capacitors with limited real estate available for the board design is not a viable solution to meet these transient requirements.

A power supply based on trans-inductor voltage regulator (TLVR) buck converter topology can be used to reduce the output capacitance while satisfying a higher transient requirement. Due to the nature of this circuit, the inductor current slew rates during transient loading will be much higher compared with regular voltage regulator buck converter topologies. However, the accurate capturing and reporting of current sense signals during transient loading transitions can lag actual current levels. The interaction between the controller device and lagging current feedback can cause undesirable ring-back issues because current is used for control.

### SUMMARY

In accordance with one aspect of the present disclosure, a power controller comprises a control loop configured to control timing of pulsed signals that activate phases of a coupled inductor voltage regulator based on current demand of a load circuit and comprises a transient detection circuit configured to determine a projected current through a compensation inductor of the coupled inductor voltage regulator based on a state of the phases and operating parameters of the coupled inductor voltage regulator. The transient detection circuit is configured to detect a transient in the current demand of the load circuit based on a variability in phase-to-phase overlap of the pulsed signals. Responsive to detecting the transient, the transient detection circuit is configured to apply a correction to the control loop that alters the timing of the pulsed signals based on the projected current through the compensation inductor.

In accordance with another aspect of the present disclosure, a method comprises determining, by a control loop, a timing of pulsed signals that activate phases of a coupled inductor voltage regulator based on current demand of a load circuit and determining, by a transient detection circuit, a projected current through a compensation inductor of the coupled inductor voltage regulator based on a state of the phases and operating parameters of the coupled inductor voltage regulator. The method also comprises monitoring, in the transient detection circuit, variability in phase-to-phase overlap of the pulsed signals to detect a transient condition in the current demand of the load circuit and during at least a portion of the transient condition, applying, by the transient detection circuit, a correction to the control loop that alters the timing of the pulsed signals based on the projected current through the compensation inductor.

In accordance with yet another aspect of the present disclosure, an apparatus comprises one or more computer readable storage media and program instructions stored on the one or more computer readable storage media. The program instructions executable by a processing system to direct the processing system to at least determine a projected current through a compensation inductor of a coupled inductor voltage regulator based on a state of phases of the coupled inductor voltage regulator and operating parameters of the coupled inductor voltage regulator and detect a transient in current demand of a load circuit supplied by the coupled inductor voltage regulator based on a variability in phase-to-phase overlap of pulsed signals. The program instructions further direct the processing system to, responsive to detecting the transient, apply a correction to a control loop that alters a timing of the pulsed signals based on the projected current through the compensation inductor.

This Summary is provided to introduce a selection of concepts in a simplified form that are further described below in the Detailed Description. It may be understood that this Summary is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 is a schematic diagram illustrating a multiphase power converter in accordance with an embodiment.

FIG. 2 illustrates a plurality of waveforms showing current and voltage responses during load circuit power changes according to an example.

FIG. 3 illustrates effects of power stage current reporting in various timing scenarios in accordance with an embodiment.

FIG. 4 is a schematic block diagram illustrating emulated current generation in accordance with an embodiment.

FIG. 5 illustrates a block diagram showing a method for calculating a current rate in accordance with an embodiment.

FIG. 6 illustrates a block diagram showing phase-wise counters for calculating emulated current in accordance with an embodiment.

FIG. 7 illustrates a timing diagram showing counter operation in accordance with an embodiment.

FIG. 8 illustrates a timing diagram showing counter operation in accordance with an embodiment.

FIG. 9 illustrates waveform response in response to an increase in load current in accordance with an embodiment.

FIG. 10 illustrates waveform response in response to a decrease in load current in accordance with an embodiment.

FIG. 11 is a flowchart showing a method for transient detection in accordance with an embodiment.

FIG. 12 illustrates a control loop in accordance with an embodiment.

FIG. 13 is a flowchart showing a method for adjusting pulsed signal timing in accordance with an embodiment.

FIG. 14 illustrates an example implementation of a control system in accordance with an embodiment.

### DETAILED DESCRIPTION

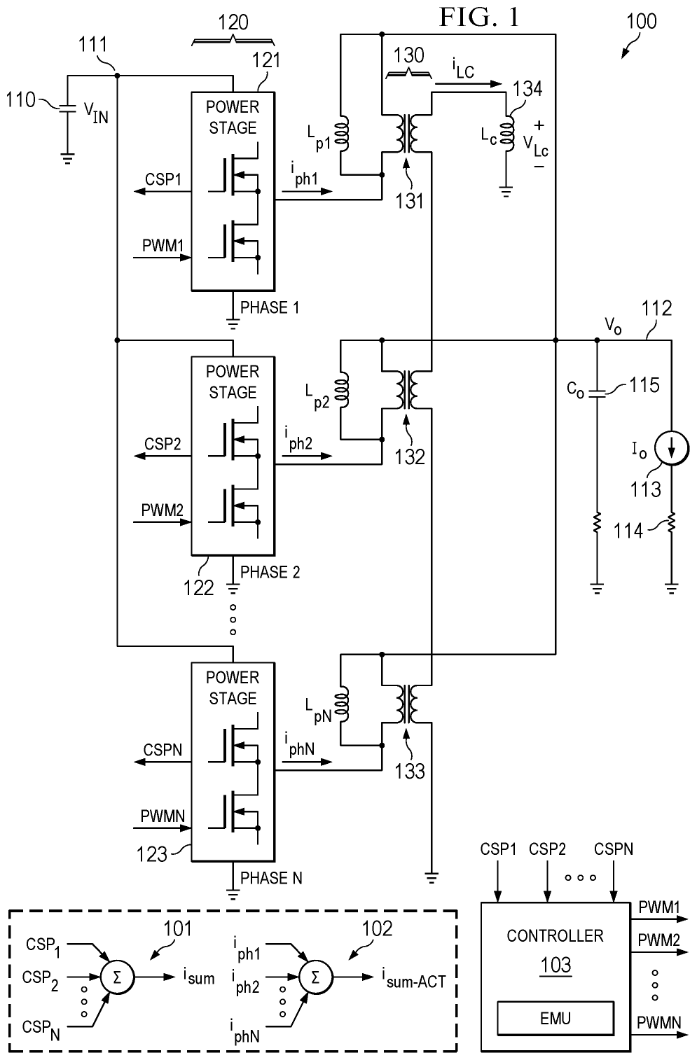

FIG. 1 illustrates a schematic diagram of a multiphase power converter 100 according to an embodiment. In particular, the multiphase power converter 100 is arranged as a trans-inductor voltage regulator (TLVR) buck converter. An input voltage 110 is supplied to an input node 111 coupled to a plurality of power stages 120. A first power stage 121 receives the voltage supplied by the input voltage 110 and generates an output current iₚₕ₁ in response to pulse width modulation (PWM) control of one or more power switches via a PWM control signal (PWM1) from a controller 103. A second power stage 122 also receives the voltage supplied by the input voltage 110 and generates an output current iₚₕ₂ in response to the PWM control of its one or more power switches via a PWM control signal (PWM2) from the control circuit. As illustrated, an Nth power stage 123 is further coupled with the input node 111 to receives the voltage supplied by the input voltage 110 to generate an output current, i_{phN}, in response to the PWM control (PWMN) of its one or more power switches.

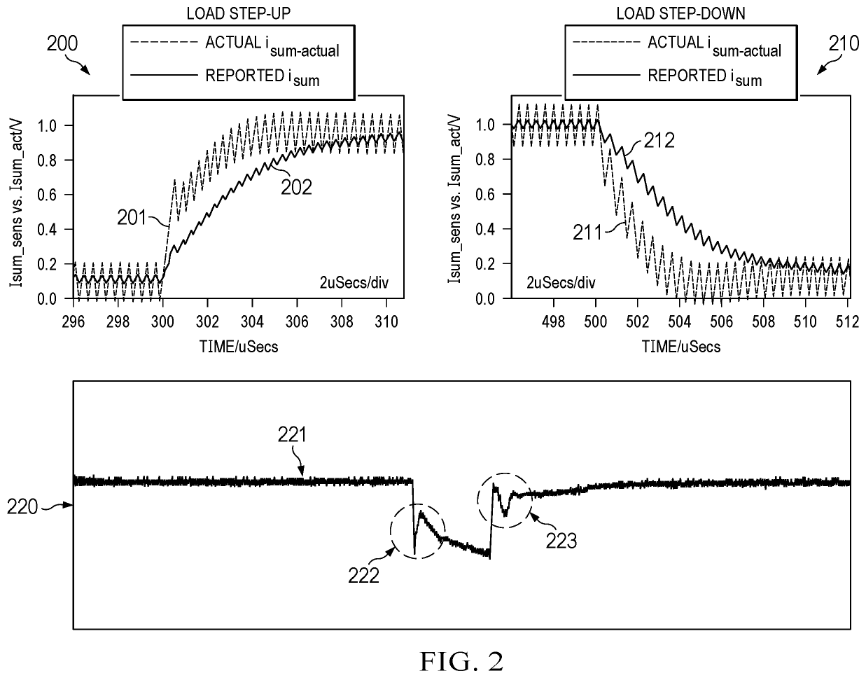

Referring to FIG. 2, first and second plots 200, 210 illustrate current transitions of the output current 113 supplied to the load circuit 114 according to an example. As shown in plot 200, a steady-state current experiences a step-up change in response to an increased demand of current from the load circuit 114 as indicated by a waveform 201 illustrating a change in the actual current in response to the current demand increase. Plot 210 shows a step-down change of current supplied to the load circuit 114 in response to a decreased demand of current. A pair of reported current waveforms 202, 212 respectively associated with the actual current waveforms 210, 211 illustrate, in an example, a slower change in the reported current than the actual current due to the manner in which the reported current is calculated. Between first steady-state portions of the waveforms 210, 211 and respectively higher and lower current value steady-state portions of the waveforms 210, 211, the transient response of the reported current waveforms 202, 212 struggles to adapt to the change in the actual currents supplied to the load 114. As a result, in a plot 220 illustrating an output voltage waveform 221, first and second ring-back events 222, 223 can be seen. The ring-back events 222, 223 are undesirable, and embodiments of this disclosure describe an improved transient response in the reported currents to reduce or eliminate the drawbacks described with respect to FIG. 2.

Returning to FIG. 1, the output currents iₚₕ₁-i_{phN} are supplied to a plurality of coupled inductors 130. In particular, the output current iₚₕ₁ is provided to a first coupled inductor 131, the output current iₚₕ₂ is provided to a second coupled inductor 132, and the output current i_{phN} is provided to an Nth coupled inductor 133. Each of the coupled inductors 131-133 includes a primary winding configured to receive the respective output currents iₚₕ₁-i_{phN} and a secondary winding. The primary windings are coupled to a common output node 112 that is also coupled with an output capacitor 115 and the load circuit 114. The secondary windings are coupled in series together with an external compensation inductor 134. The external compensation inductor 134 couples a change in current in one of the phases 120 (e.g., power stage 121) with the rest of the phases 120 (e.g., power stages 122, 123). In this manner, voltage droop in the output voltage is small.

A summer 102 is illustrated to represent the summing of the actual currents (e.g., iₚₕ₁, iₚₕ₂, i_{phN}, etc.) into a single current value i_{sum-ACT} that creates the output current 113 supplied to a load circuit 114 in response to feeding the currents iₚₕ₁, iₚₕ₂, i_{phN} into the same common output node 112. In the circuit illustrated in FIG. 1, physical hardware for measuring the actual currents is not utilized. Such hardware can take up valuable real estate on the printed circuit board (PCB) supporting the multiphase power converter 100. The multiphase power converter 100 instead generates emulated currents (e.g., CSP1, CSP2, CSPN, etc.) in each of the respective power stages 121-123 to be summed (as illustrated by a current summer 101) within the controller 103 to generate a summed current signal iₛᵤₘ for use by the controller 103 to generate the PWM control signals PWM1, PWM2, PWMN, etc. Each emulated current generated by a respective power stage 121-123 represents the actual current (e.g., iₚₕ₁, iₚₕ₂, i_{phN}, etc.) generated as its output current and supplied to the respective power stages 121-123.

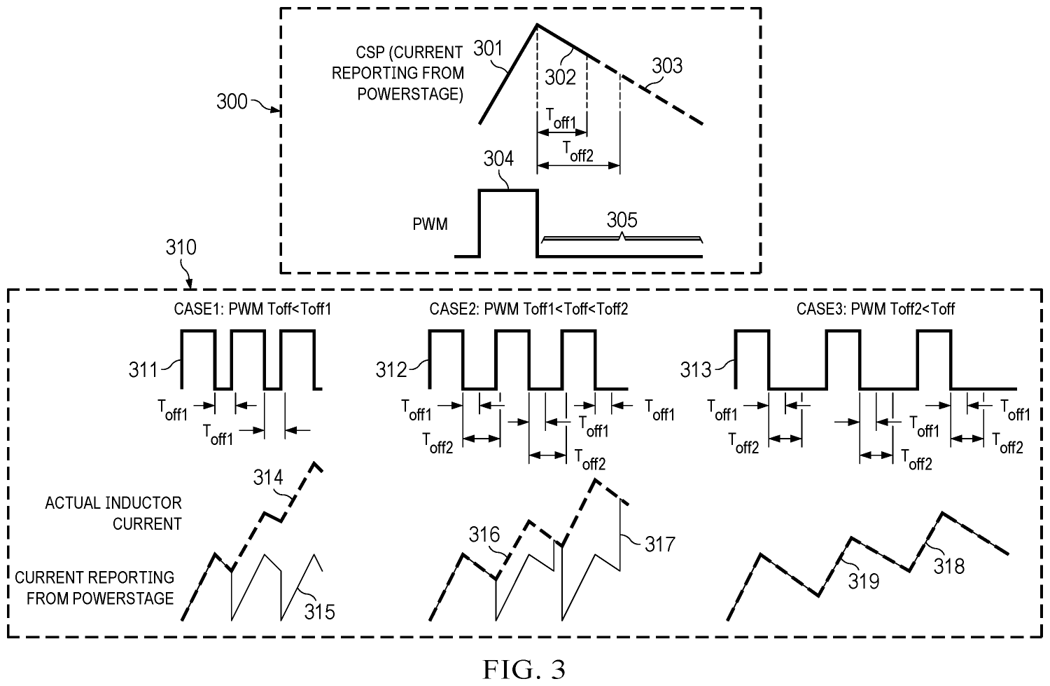

Referring to FIG. 3, power stage current phases and effects of power stage current reporting in various timing scenarios are illustrated in accordance with an embodiment. A power stage current reporting block 300 illustrates a relationship between an example current waveform (1001-1003) experienced through the primary windings of the coupled inductors 131-133 in response to a corresponding PWM signal 304 transmitted to respective power stages 121-123. During an ON pulse of the PWM signal 304, the current portion 301 illustrates increasing current flowing through the primary winding. Reporting of the current during the rising current portion 301 is emulated within the power stage.

Each power stage 121-123 is designed to have a Toff1 time and a Toff2 time. In a single system arrangement such as the multiphase power converter 100, the Toff1 and Toff2 times of all included power stages may be chosen to be similar or substantially similar. However, one or more of the power stages 121-123 may have distinct Toff1 and/or Toff2 times. In one embodiment, the Toff1 and Toff2 times begin in response to a falling edge of the pulse of the PWM signal 304. During the Toff1 time, current is decreasing through the primary winding of the respective coupled inductor 131-133 and is also emulated within the power stage. Beginning at Toff1, emulation of the decreasing current is ended, and actual sensed current is reported to the controller 103. In response to reaching Toff2, the DC value of the current in the power stage is updated while the actual current remains being reported to the controller 103.

FIG. 3 illustrates current reporting examples 310 in response to different off times 305 of the PWM signal 304. A PWM signal 311 is illustrated corresponding with a first case example having an off time 305 sufficiently fast such that the off time (Toff) 305 between consecutive PWM pulses is shorter than the Toff1 time. During the first PWM pulse cycle corresponding with the first pulse and first Toff time, a reported power stage current 315 accurately reflects an actual inductor current 314 experienced by the respective primary winding. However, subsequent PWM cycles cause the reported power stage current 315 to deviate from the actual inductor current 314. As shown during a second PWM cycle, the shape of the reported power stage current 315 matches the shape of the actual inductor current 314. For example, the rising portions of the currents 314, 315 have a same or similar increasing slope, and the falling portions of the currents 314, 315 have a same or similar decreasing slope. However, the DC value of the current in the power stage fails to be reset or updated due to the Toff time being shorter than the Toff2 time.

In a second illustrated case example, a PWM signal 312 is illustrated as having a Toff time 305 longer than the Toff1 time but shorter than the Toff2 time. As shown, the slopes of the rising portions of the actual inductor current 316 and reported power stage current 317 are similar as are the slopes of the decreasing portions corresponding to the Toff1 times. The decreasing current portions corresponding with the portion between the Toff1 and Toff2 times also have matching slopes. However, in response to the actual current being reported after the Toff1 time, the DC value of the reported power stage current 317 matches the DC value of the actual inductor current 316. Unfortunately, the DC value of the reported power stage current 317 is not updated as is done in response to reaching the Toff2 time. As such, the beginning of each PWM cycle beginning with the rising edge of the PWM pulse includes starting the reported power stage current 317 from DC values that fail to match the corresponding DC values of the actual inductor current 316.

In a third illustrated example, a PWM signal 313 is illustrated as having a Toff time 305 longer than the Toff2 time. As shown, the slopes of the rising and falling edges of the actual inductor current 318 and reported power stage current 319 match throughout the PWM cycle. In addition, in response to reaching and exceeding the Toff2 time as illustrated, the DC value of the current in the power stage is updated such that it substantially represents the actual inductor current 318 in each of the PWM cycles.

Embodiments of this disclosure provide compensation for differences between the actual currents experienced by the external compensation inductor 134 and the emulated currents reported to the controller 103 from the plurality of power stages 120.

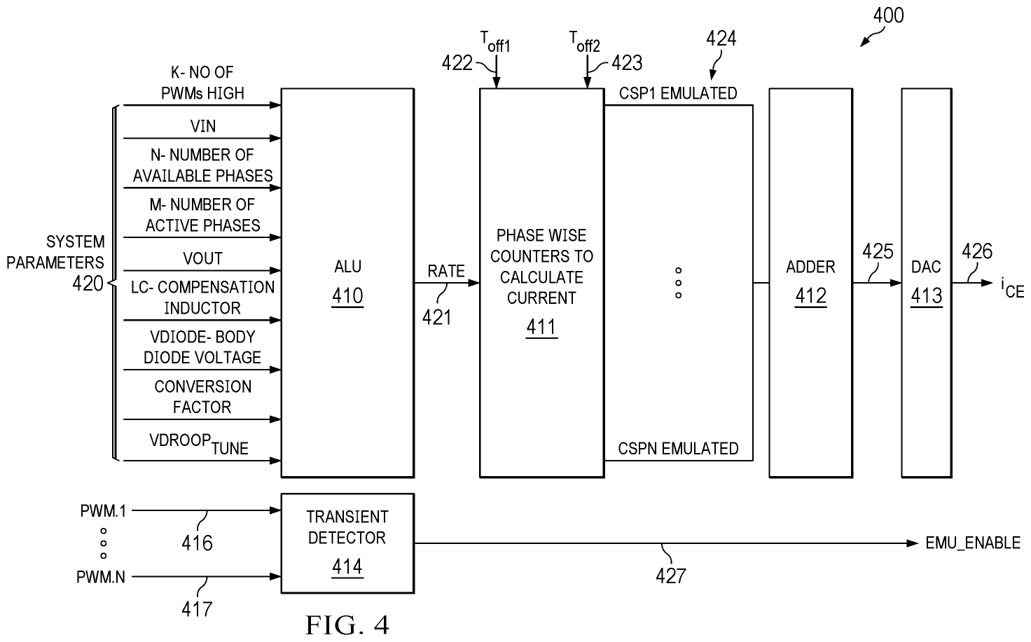

FIG. 4 illustrates schematic block diagram illustrating a digital emulated current generator 400 according to an example. In one embodiment, the digital emulated current generator 400 is performed by the controller 103. The generator 400 includes an arithmetic logic unit (ALU) 410 that receives a plurality of system parameters 420. The system parameters 420 include a value (Vin) of the input voltage (e.g., input voltage 110), a value (Vout) of the output voltage (e.g., at the output node 112), an inductance value (Lc) of the external compensation inductor 134, a body diode voltage value (Vdiode) of the low-side FET of the power stages 121-123, a Vdroop tuning value (Vdroopₜᵤₙₑ) used to account for measurement accuracy of Vdroop in the controller 103 due to bandwidth or offset conditions, etc., and a conversion factor (Conv_{fact}) that may include one or more of the clock period at which the controller 103 is running, a digital-to-analog (DAC) conversion scale, and a current to voltage conversion ratio. The Lc. Vdiode, and conversion factor values may be obtained from memory such as non-volatile memory within the controller 103. Additional system parameters may be obtained from inputs to the controller 103 indicating the number (K) of power stages 121-123 currently in an on, HIGH state (e.g., with controlling PWM signals HIGH), the number (M) of phases whose PWMs are actively switching, and the number (N) of phases available for the system.

In one embodiment, a compensation rate 421 is calculated based on the system parameters 420 using the formula:

$$Rate = ( K \times Vin - N \times ( Vout - Vdroo {p}_{t u n e} + Vdiode ) + M \times Vdiode ) \times \frac{C o n {v}_{fact}}{L c} . \qquad ( Eqn . 1 )$$

In another embodiment, a compensation rate 421 is calculated based on the system parameters 420 using the formula:

$$Rate = ( K \times Vin - N \times ( Vout ) - ( N - M ) \times Vdiode ) \times \frac{C o n {v}_{fact}}{L c} . \qquad ( Eqn . 2 )$$

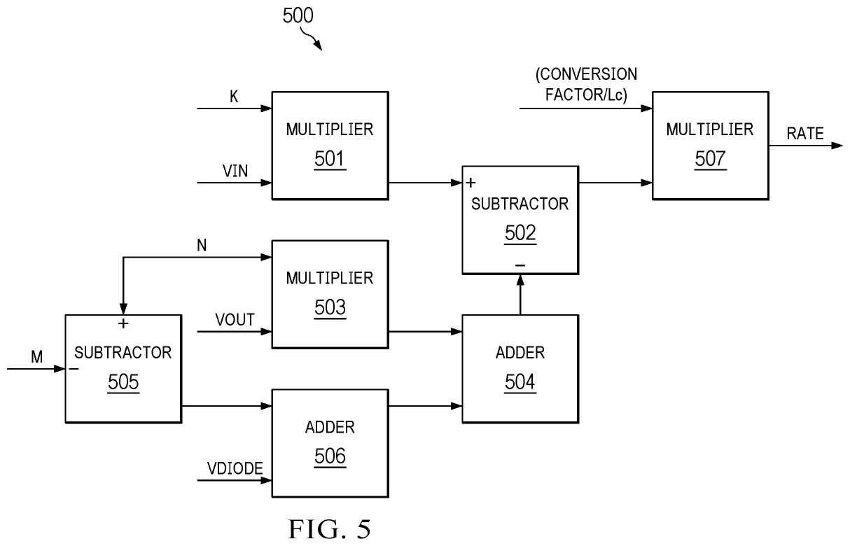

FIG. 5 illustrates a block diagram showing a method 500 for calculating the rate based on Eqn. 2 according to an embodiment. A first multiplier 501 receives the K value and the Vin value and multiplies them together. The multiplication product is provided to a first subtractor 502.

The N value is provided to a second multiplier 503. The second multiplier 503 also receives the Vout input, generates a product of the N and Vout inputs, and provides the product to a first adder 504. The N value is also provided to a second subtractor 505. The M value is provided to the second subtractor 505. M is subtracted from N in the second subtractor 505, which outputs the difference to a second adder 506. The adder 506 adds the Vdiode input to the N−M difference and provides the sum to the first adder 504. The first adder 504 sums the N*Vout product and the (N−M)*Vdiode product and provides them to the first subtractor 502 to be subtracted from the K*Vin product. The resulting difference is provided to a third multiplier 507 to be multiplied with a quotient based on the conversion factor divided by the inductance of the external compensation inductor 134. The final product produced by the multiplier 507 is output as the generated Rate of Eqn. 2.

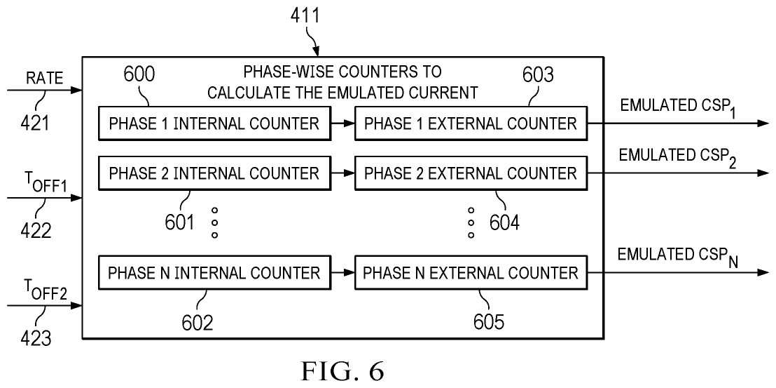

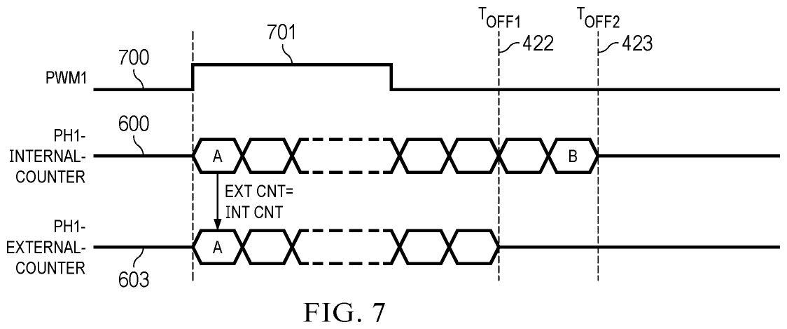

Returning to FIG. 4, the calculated rate 421 together with inputs for the first off time, Toff1 422, and the second off time, Toff2 423, provided to a current calculator block 411 having counters dedicated to respective power stages 121-123 for digitally emulating the current generated in response to the PWM signals PWM1-PWMN. As illustrated in FIG. 6, the current calculator block 411 includes internal counters 600, 601, 602 and external counters 603, 604, 605 for determining the emulated current values for separate phases (e.g., Phase 1, Phase 2, Phase N) corresponding with respective power stages 121-123. FIG. 7 illustrates an example operation of the internal and external counters 600, 603 for Phase 1 corresponding with operation of the power stage 121. Referring to FIGS. 6 and 7, at the beginning of the PWM signal cycle starting with a rising edge 700 of a PWM pulse 701, the value of the internal counter 600 is copied to the external counter 603, and the counters 600, 603 begin incrementing or decrementing based on the rate 421. The external counter 603 increments or decrements through to the end of the first off time Toff1 422 while the internal counter 600 remains incrementing or decrementing to the end of the second off time Toff2 423. As shown in FIG. 6, the external counter 603 exports its value as an emulated CSP1 value. The Phase 2 through Phase N external counters 604-605 similarly export their values for their respective phases (e.g., Phase 2 to Phase N) for further processing by the digital emulated current generator 400.

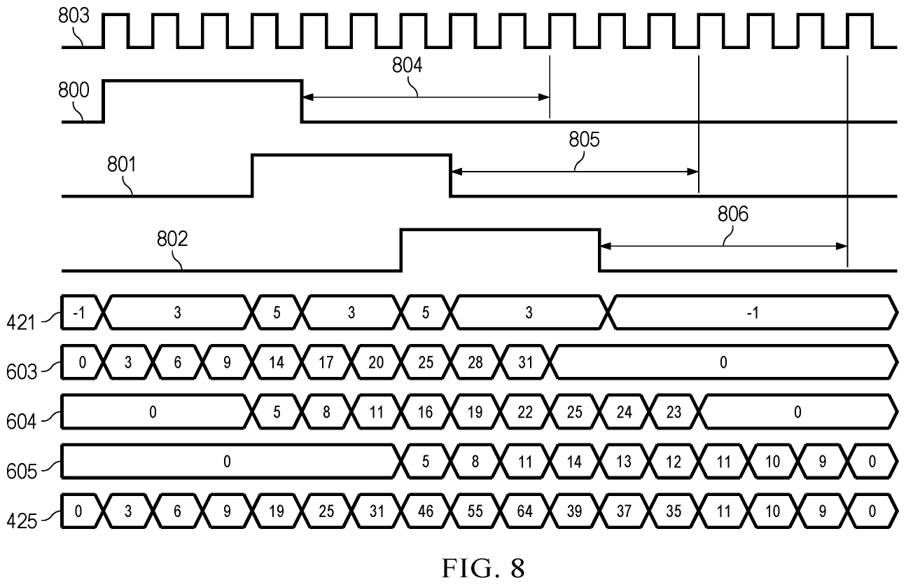

As illustrated in FIG. 4, the emulated CSP1-CSPN values are provided to an adder 412 that combines the emulated currents into a summed emulated current output 425. FIG. 8 shows a waveform of an exemplary implementation of the calculation of emulated currents and their summation based on PWM signals 800, 801, 802. A clock signal 803 provides timing for the PWM signals 800-802 as well as for the calculations output by the digital ALU 410 (e.g., the illustrated rate 421 output), the external counters 603-605, and the adder 412 (e.g., the summed emulated current output 425).

Each of the external counters 603-605 begins counting the rate signal 421 values with the rising edge of the pulse of their respective PWM signals 800-802 and cease counting at the end of their respective Toff1 times 804-806. The first external counter 603 counts three times by 3, one time by 5, two times by 3, one time by 5, and two more times by 3. The second external counter 604 counts one time by 5, two times by 3, one time by 5, three times by 3, and two times by −1. The third external counter 605 counts one time by 5, three times by 3, and five times by −1. The sum of the counter values during each clock cycle are illustrated in the summed emulated current output 425.

Returning to FIG. 4, digital-to-analog converter (DAC) 413 converts the digital summed emulated current output 425 into an analog compensation signal, ICH 426. As described with respect to FIG. 2, transient response struggles to adapt to the change in the actual currents supplied to the load 114. During such transient events, compensating the current reporting by the power stages 121-123 by incorporating the analog compensation signal, ICE 426 into the feedback control loop improves current response and reduces ring backs during such transient conditions. However, it is not necessary to incorporate the analog compensation signal 426 outside of transient events. Accordingly, embodiments of this disclosure contemplate detection of load current transient events for applying determined compensation during the transient periods. Outside of the transient periods, the compensation signal 426 is not provided to the feedback control loop.

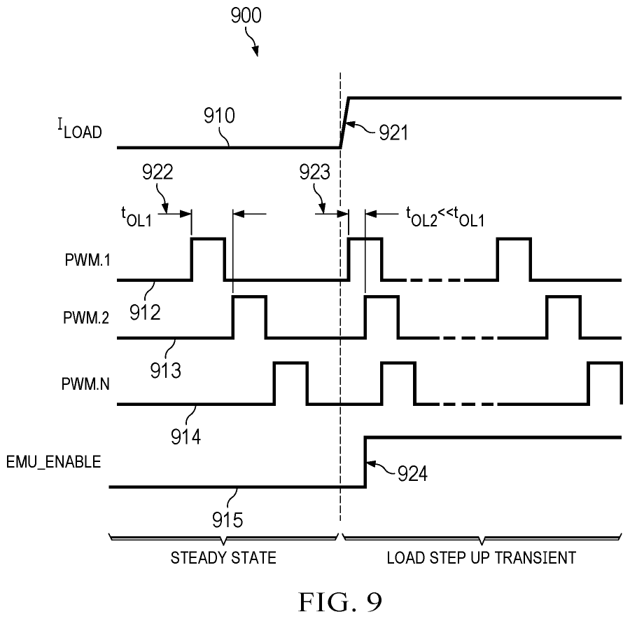

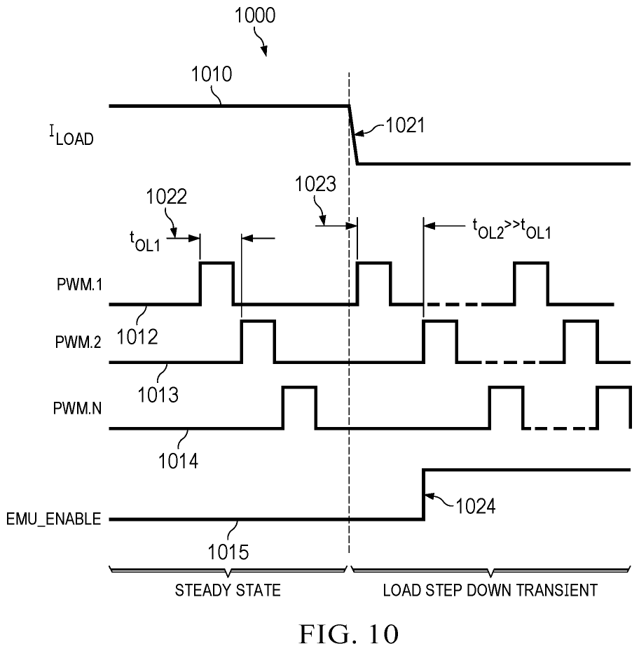

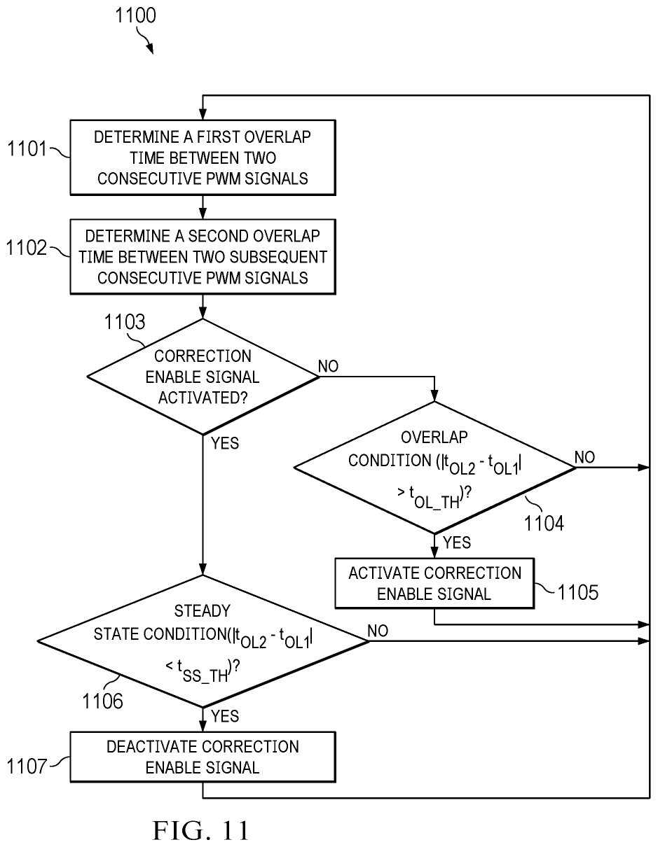

Thus, as illustrated in FIG. 4, the controller 103 also includes a transient detector block 414 configured to identify transients in the load current for switching application of the compensation signal 426 into the control loop. FIGS. 9 and 10 illustrate waveforms 900, 1000 showing load current transient conditions according to embodiments. FIG. 11 illustrates implementation of transient detection via a flowchart of a procedure 1100 for determining load current transients and controlling activation of a correction enable signal according to an embodiment.

Referring to FIGS. 9-11, load currents 910, 1010 begin in a steady-state mode and transition to a higher or lower load current at respective transition events 921, 1021. During the steady-state mode, an overlap time, t_{OL1}, 922, 1022 between consecutive pulses between adjacent PWM signals 912-914, 1012-1014 may be similar or may vary as the controller 103 that generates the signals 912-914, 1012-1014 operates the multiphase power converter 100 to generate the desired load current. For example, the overlap times between consecutive PWM signals of FIG. 9 (PWM1 signal 912 and PWM2 signal 913, PWM2 signal 913 and PWMN signal 914, or PWMN signal 914 and PWM1 signal 912) may be similar or may vary as may the PWM signals of FIG. 10 (PWM1 signal 1012 and PWM2 signal 1013, PWM2 signal 1013 and PWMN signal 1014, or PWMN signal 1014 and PWM1 signal 1012). In attempting to maintain an equal degree of separation between operation of the power stages 121-123 to optimize current ripple in the output voltage, the controller 103 may tend to equalize the overlap time between the consecutive PWM signals.

In response to a load current transient condition where a step-up transition 921 or a step-down transition 1021 causes a change in the load current 910, 1010, the overlap times of the consecutive PWM signals 912-914, 1012-1014 will change accordingly. As shown in FIG. 9, the step-up transition 921 increases the load current demand, and the overlap times, t_{OL2}, 923, 1023 between consecutive signals (e.g., PWM1 signal 912 and PWM2 signal 913) decreases. As shown in FIG. 10, the step-up transition 1021 increases the load current demand, and the overlap times, t_{OL2}, between consecutive signals (e.g., PWM1 signal 1012 and PWM2 signal 1013) increases.

The increase or decrease in overlap times, t_{OL2}, compared with the overlap times, t_{OL1}, is captured in the procedure 1100 by determining, at a first block 1101, a first overlap time (e.g., t_{OL1}) between two consecutive signals. At a second block 1102, a second overlap time (e.g., t_{OL2}) is determined between two subsequent consecutive signals. If the correction enable signal (EMU_ENABLE) is not activated (block 1103), the subsequent overlap time, t_{OL2}, is compared (block 1104) with the previous overlap time, t_{OL1}, to determine if the difference between the overlap times t_{OL1} and t_{OL2} are sufficiently large to indicate that a load current transient condition has occurred. The difference between the overlap times t_{OL1} and t_{OL2} is compared with an overlap time threshold, t_{OL_TH}. If an absolute value of the overlap time difference meets or exceeds the threshold, for example, the presence of a load current transient condition may be indicated. If so, the correction enable signal is activated at block 1105, and the procedure 1100 returns to block 1101 to iterate another round of overlap time checking. Enablement of the correction enable signal (EMU_ENABLE 915, 1015) is illustrated in FIGS. 9 and 10 at transitions 924, 1024. If the absolute value of the overlap time difference does not meet or exceed the threshold, the procedure 1100 returns to block 1101 to iterate another round of overlap time checking.

If the correction enable signal (EMU_ENABLE) is activated (block 1103), the difference between the overlap times t_{OL1} and t_{OL2} is compared with a steady-state condition threshold, t_{SS_TH}. In one embodiment, the steady-state condition threshold is less than the overlap time threshold, and absolute values of the differences between the overlap times t_{OL1} and t_{OL2} less than or equal to the steady-state condition threshold indicate that a load current transition period is not present. When reaching the steady-state condition threshold after experiencing a load current transition period, the load current transition period has ended. At block 1106, the absolute difference between the overlap times t_{OL1} and t_{OL2} is compared with the steady-state condition threshold, t_{SS_TH}. If the steady-state condition is not met, no change to the correction enable signal is made, and procedure 1100 returns to block 1101 to iterate another round of overlap time checking. If the steady-state condition is met, the correction enable signal is deactivated at block 1107, and procedure 1100 returns to block 1101 to iterate another round of overlap time checking.

In alternative embodiments, transient events may be determined by measuring the on times (Ton) of the PWM signals 912-914 or may be inferred without direct current sensing based on sudden and dramatic changes in the PWM outputs to keep the output voltage regulated.

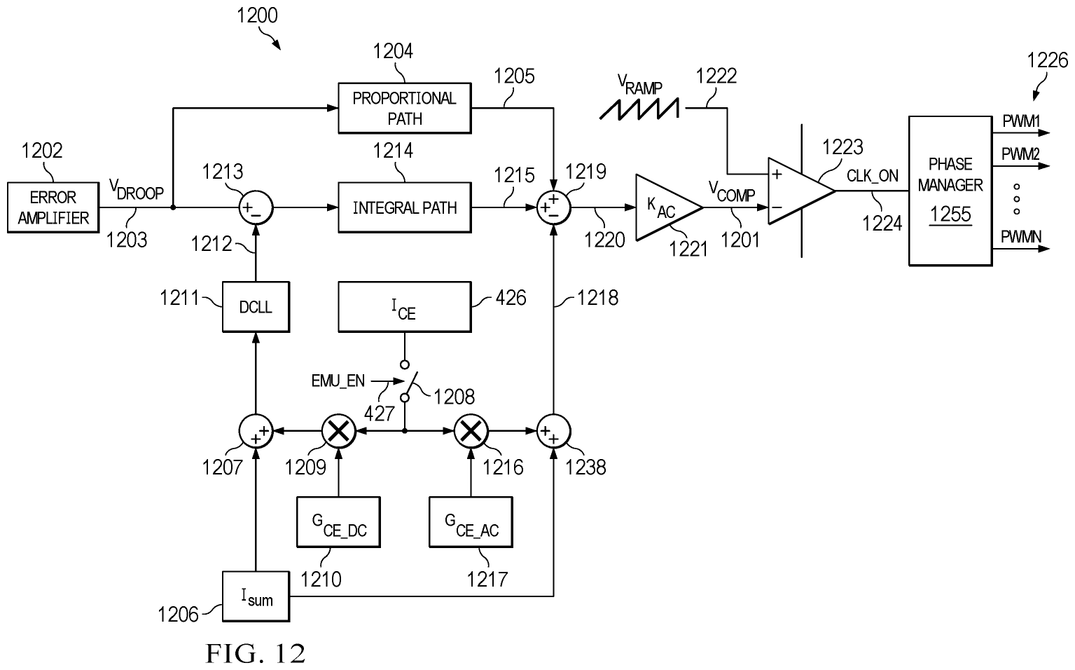

FIG. 12 illustrates a feedback control loop 1200 for generating PWM control signals according to an embodiment. A voltage compensation signal, V_{comp}, 1201 is generated based on a sum of three signal paths within the control loop 1200. The control loop 1200 An error amplifier 1202 subtracts sensed output voltage from an output voltage target to generate a droop voltage 1203. A first signal path within the control loop 1200 includes a proportional path 1204 that receives the droop voltage 1203 and generates a proportional output 1205.

A second signal path within the control loop 1200 is based on receiving the sum of reported current, Iₛᵤₘ, 1206 provided by, for example, the emulated current summer 101 of FIG. 1. Iₛᵤₘ 1206 is provided to a summer 1207 configured to modify the Iₛᵤₘ 1206 during a load current transient event if present. For example, the analog compensation signal, ICE, 426 (FIG. 4) is provided to the control loop 1200 by a switch 1208 controlled by the emulation enable signal 427 (FIG. 4). If provided, the ICE 426 is modified to a DC portion of the control loop 1200 by a mixer 1209 that combines the ICE 426 and a DC emulated current gain 1210. The product of the mixer 1209 is added with the Iₛᵤₘ 1206 in the summer 1207, and the sum is provided to the DC load line 1211 to generate an ideal droop value 1212. A difference signal generated by a summer 1213 of a difference between the droop voltage 1203 and the ideal droop value 1212 is provided to an integral path 1214 that creates an error voltage and adjusts the setpoint of the V_{comp} signal 1201 to generate an integral output 1215 that drives the output voltage error to zero.

A third signal path within the control loop 1200 is based on the Iₛᵤₘ 1206. If a load current transient event is present, the DAC output 426 is combined in a mixer 1216 for providing correction to an AC portion of the control loop 1200. The mixer 1216 combines the ICE 426 and an AC emulated current gain 1217. The product of the mixer 1216 is added with the Iₛᵤₘ 1206 in a summer 1235 that generates a current feedback output 1218.

The outputs of the three signal paths (e.g., the proportional output 1205, the integral output 1215, and the current feedback output 1218) are combined in a summer 1219 to generate a raw voltage compensation signal 1220 that is scaled by a scaler 1221 to produce the scaled voltage compensation signal 1201. A compensating ramp signal, V_{RAMP}, 1222 has a slope proportional to the number of phases or power stages 121-123 and switching frequency setting. In response to detecting the intersection of the V_{RAMP} 1222 and V_{COMP} 1201 signals via a loop comparator 1260, the controller 103 fires a new clock pulse in a clock signal 1223. Based on the clock signal 1223, a phase manager 1261 within the controller 103 generates corresponding PWM signals 1262 (e.g., PWM1-PWMN) for controlling the power stages 121-123.

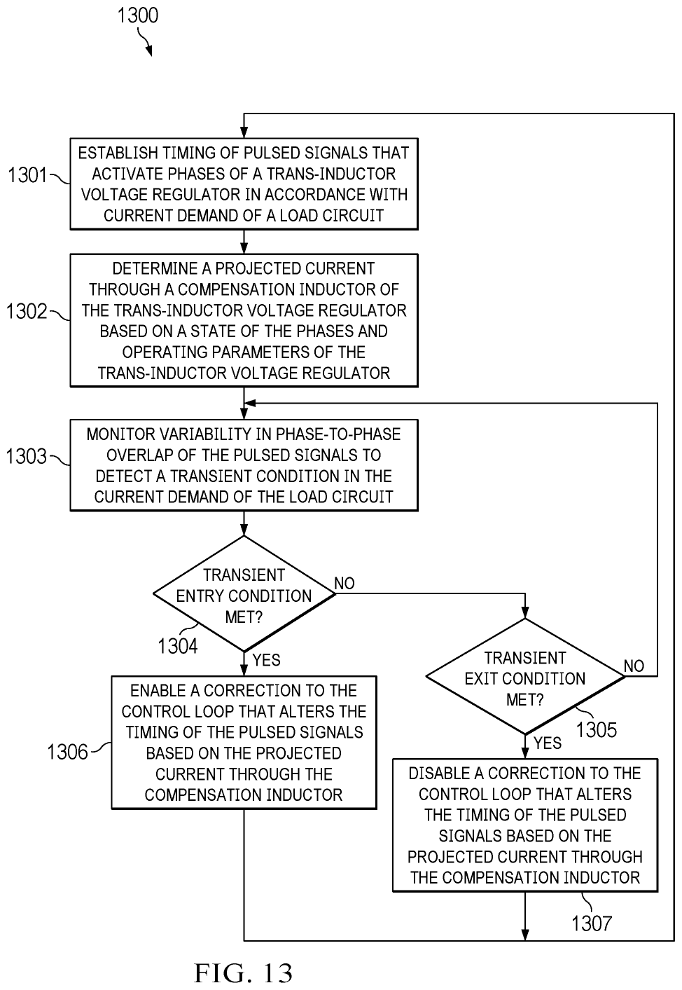

FIG. 13 is a flowchart showing a method 1300 for adjusting pulsed signal timing in accordance with an embodiment. Method 1300 may incorporate some or all of procedure 1100 of FIG. 11 in one embodiment. Method 1300 begins at step 1301 with establishing or controlling timing of pulsed signals that activate phases of a coupled inductor voltage regulator in accordance with current demand of a load circuit. For example, the PWM control signals 1262 generated via help from the control loop 1200 of FIG. 12 are used to control the power stages 121-123 to generate the output voltage 112. At step 1302, a projected current through a compensation inductor of the coupled inductor voltage regulator based on a state of the phases and operating parameters of the coupled inductor voltage regulator is determined. For example, the digital emulated current generator 400 generates a current rate 421 and uses phase-wise counters 411 to generate emulated current output 426. Variability in phase-to-phase overlap of the pulsed signals to detect a transient condition in the current demand of the load circuit is monitored at step 1303. As illustrated in FIGS. 9, 10 overlap times Toff1 and Toff2 are used to detect transit entry and exit conditions in the load current demand.

If, at step 1304, a transient entry condition is met, a correction to the control loop that alters the timing of the pulsed signals based on the projected current through the compensation inductor is enabled at step 1306. Procedure 1300 then returns to step 1301 for another iteration cycle. If, at step 1304, a transient entry condition is not met, a transient exit condition is tested at step 1305. If the transient exit condition is met, the correction to the control loop is disabled at step 1307, and procedure 1300 returns to step 1301 for another iteration cycle. If, at step 1305, the transient exit condition is not met, procedure 1300 returns to step 1303 to keep monitoring for the transient exit condition. Correction activation and deactivation are determined, for example, based on the detection of transient periods in the load current as facilitated by the procedure 1100 of FIG. 11.

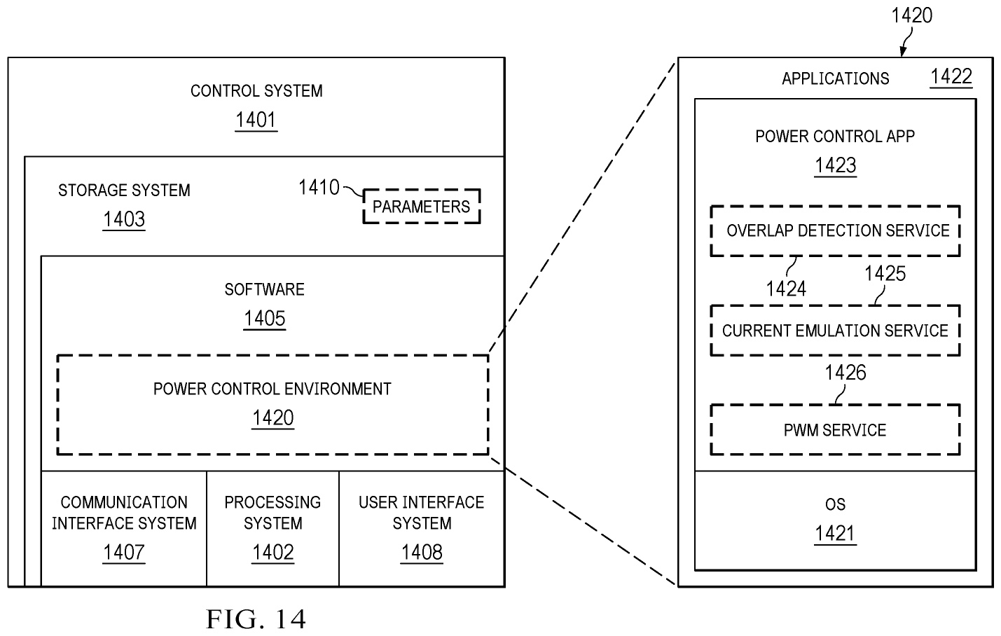

FIG. 14 illustrates an example implementation of a control system capable of implementing any of the control schemes discussed herein. FIG. 14 includes control system 1401. Control system 1401 is representative of any system or collection of systems in which the various operational techniques, architectures, scenarios, and processes disclosed herein may be implemented. For example, control system 1401 can be used to implement controller or control portions of multiphase power converter 100 of FIG. 1, digital emulated current generator 400 of FIG. 4, correction enable signal activation of FIG. 11, feedback loop control of FIG. 14, or any of the control, transient detection, or transient correction of any of the Figures herein.

Control system 1401 may be implemented as a single apparatus, system, or device or may be implemented in a distributed manner as multiple apparatuses, systems, or devices. Control system 1401 includes, but is not limited to, processing system 1402, storage system 1403, software 1405, communication interface system 1407, and user interface system 1408. Processing system 1402 is operatively coupled with storage system 1403, communication interface system 1407, and user interface system 1408.

Processing system 1402 loads and executes software 1405 from storage system 1403. When executed by processing system 1402 to control a power system to affect designated load regulation, transient detection, and correction enable signal activation/enablement operations, software 1405 directs processing system 1402 to operate as described herein for at least the various processes, operational scenarios, and sequences discussed in the foregoing implementations. Control system 1401 may optionally include additional devices, features, or functionality not discussed for purposes of brevity.

Processing system 1402 may comprise processing circuitry that retrieves and executes software 1405 from storage system 1403. Processing system 1402 may be implemented within a single processing device but may also be distributed across multiple processing devices or sub-systems that cooperate in executing program instructions. Examples of processing system 1402 include general purpose central processing units, application specific processors, graphics processing units, programmable logic devices, field-programmable logic devices, application specific integrated circuit devices, digital signal processors, and discrete logic, as well as any other type of processing device and supporting circuitry, combinations, or variations thereof.

Storage system 1403 may comprise any tangible computer readable storage media readable by processing system 1402 and capable of storing software 1405. Storage system 1403 may include volatile and nonvolatile, removable and non-removable media implemented in any method or technology for storage of information, such as computer readable instructions, data structures, control programs, program modules, or other data. Examples of storage media include random access memory, read only memory, magnetic disks, optical disks, flash memory, virtual memory and non-virtual memory, magnetic storage media, magnetic storage devices, or any other suitable storage media. In no case is the computer readable storage media a propagated signal. In addition to computer readable storage media, in some implementations storage system 1403 may also include computer readable communication media over which at least some of software 1405 may be communicated internally or externally. Storage system 1403 may be implemented as a single storage device but may also be implemented across multiple storage devices or sub-systems co-located or distributed relative to each other. Storage system 1403 may comprise additional elements, such as a controller, capable of communicating with processing system 1402 or possibly other systems.

Software 1405 may be implemented in program instructions and among other functions may, when executed by processing system 1402, direct processing system 1402 to operate as described with respect to the various operational scenarios, sequences, and processes illustrated herein. For example, software 1405 may include program instructions comprising power control environment 1420 to implement operations 1100, 1300 illustrated in FIGS. 11, 13 or other operations discussed herein. In particular, the program instructions may include various components or modules that cooperate or otherwise interact to carry out the various processes and operational scenarios described herein. The various components or modules may be implemented in compiled or interpreted instructions, or in some other variation or combination of instructions. Software 1405 may include additional processes, programs, or components, such as operating system software (e.g., 1421) or other application software (e.g., 1422), in addition to or that include power control environment 1420. Software 1405 may also comprise firmware or some other form of machine-readable processing instructions executable by processing system 1402.

Software 1405, when loaded into processing system 1402 and executed, may transform a suitable apparatus, system, or device (of which control system 1401 is representative) overall from a general-purpose computing system into a special-purpose computing system customized to control a power system to affect load regulation, transient detection, feedback control loop correction operations, among other control operations. Indeed, encoding software 1405 on storage system 1403 may transform the physical structure of storage system 1403. For example, if the computer-readable storage media are implemented as semiconductor-based memory, software 1405 may transform the physical state of the semiconductor memory when the program instructions are encoded therein, such as by transforming the state of transistors, capacitors, or other discrete circuit elements constituting the semiconductor memory. A similar transformation may occur with respect to solid-state media, magnetic media, or optical media. Other transformations of physical media are possible without departing from the scope of the present description, with the foregoing examples provided only to facilitate the present discussion.

In one example implementation, software 1405 includes control process power control environment 1420 comprising operating system 1421 and applications 1422, at least some of which are representative of the operational techniques, algorithms, architectures, scenarios, and processes discussed with respect to the included Figures. Software 1405 can also employ parameters 1410 stored by storage system 1403. Parameters 1410 include system parameters 420, which can be representative of any programmable registers, software-defined parameters, status indicators, user-controlled feature settings, or adjustment parameters discussed herein.

Applications 1422 can implement a power control application 1423 that includes overlap detection service 1424, current emulation service 1425, and PWM service 1426. One or more software or firmware modules can perform functions of these services, and such modules can provide shared or distributed functionality. Overlap detection service 1424 is configured to monitor an overlap in timing among pulse signals associated with voltage conversion phases supplying current to a load circuit. Current emulation service 1424 determines current emulation signals from parameters 1410.

From monitored timing among pulse signals, overlap detection service 1424 is configured to monitor variability in phase-to-phase overlap of pulsed signals to detect a transient condition in the current demand of a load circuit. Based on the monitored variability, if a transit entry condition is met, a correction to the control loop that alters the timing of pulsed signals based on the projected current through the compensation inductor is enabled. If a transit exit condition is met, correction to the control loop that alters the timing of pulsed signals based on the projected current through the compensation inductor is disabled.

The current emulation service 1425 is configured to determine a counter rate based on system parameters 420 and based on power stage parameters. Current emulation service 1425 is also configured to generate emulated current compensation signals. The PWM service 1426 can control various external circuitry that mitigates or corrects various undershoot or overshoot conditions and provides enhanced transient response for a power system. For example, based at least on the indication of the transient event condition, PWM service 1426 is configured to generate PWM control signals based on the emulated current compensation signals to increase transient response.

Communication interface system 1407 may include communication connections and devices that allow for communication with various circuit elements, such as discrete circuit elements, transistors, interface logic, A/D or D/A conversion units, or electrical components over communication links or communication networks (not shown). Examples of connections and devices that allow for communication may include logic interfaces, off-chip communication elements, signal drivers, signal receivers, transceivers, network interface controllers, and other communication circuitry. The connections and devices may communicate over communication media to exchange communications with other computing systems or networks of systems, such as metal, glass, air, or any other suitable communication media. Communication between control system 1401 and other elements or systems (not shown) via communication interface system 1407 may occur over data links, control links, communication links, or communication networks and in accordance with various communication protocols, combinations of protocols, or variations thereof. For example, control system 1401 might transfer control signaling over digital communication links comprising Ethernet interfaces, serial interfaces, serial peripheral interface (SPI) links, inter-integrated circuit (I2C) interfaces, universal serial bus (USB) interfaces, UART interfaces, discrete signaling, or wireless interfaces.

User interface system 1408 may include interfacing elements to receive user or operator programmed settings for operation of a power control system, such as for changing parameters 1410. User interface system 1408 can also provide feedback to users or operators on present settings held within parameters 1410. In some examples, user interface system 1408 receives and transfers various information over communication interface system 1407. User interface system 1408 may include separate user interface elements which include a software interface such as a terminal interface, command line interface, or application programming interface (API). User interface system 1408 may also include physical user interfaces, such as keyboard, a mouse, a voice input device, or a touchscreen input device for receiving input from a user. User interface system 1408 may include visualization/status interfaces, user command controls, and telemetry, such as user controls, start/stop controls, telemetry, operating mode control interfaces, visualization interfaces, and system characteristic calibration controls, among others. Output devices such as displays, speakers, web interfaces, terminal interfaces, and other types of output devices may also be included in user interface system 1408. User interface system 1408 may also include associated user interface software executable by processing system 1402 in support of the various user input and output devices discussed above.

The techniques described in this disclosure may also be embodied or encoded in an article of manufacture including a non-transitory computer-readable storage medium. Example non-transitory computer-readable storage media may include random access memory (RAM), read-only memory (ROM), programmable ROM, erasable programmable ROM, electronically erasable programmable ROM, flash memory, a solid-state drive, a hard disk, magnetic media, optical media, or any other computer readable storage devices or tangible computer readable media. The term “non-transitory” may indicate that the storage medium is not embodied in a carrier wave or a propagated signal. In certain examples, a non-transitory storage medium may store data that can, over time, change (e.g., in RAM or cache).

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The various circuit elements and interconnection architectures discussed herein are employed according to the descriptions above. However, it should be understood that the disclosures and enhancements herein are not limited to these circuit elements and interconnection architectures. Thus, the descriptions and figures included herein depict specific implementations to teach those skilled in the art how to make and use the best options. For the purpose of teaching inventive principles, some conventional aspects have been simplified or omitted. Those skilled in the art will appreciate variations from these implementations that fall within the scope of this disclosure. Those skilled in the art will also appreciate that the features described above can be combined in various ways to form multiple implementations.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin,” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, such as by an end user and/or a third party.

While the use of particular transistors is described herein, other transistors (or equivalent devices) may be used instead. For example, a p-channel field effect transistor (PFET) may be used in place of an n-channel field effect transistor (NFET) with little or no changes to the circuit. Furthermore, other types of transistors may be used (such as bipolar junction transistors (BJTs)). Furthermore, the devices may be implemented in/over a silicon substrate (Si), a silicon carbide substrate (SiC), a gallium nitride substrate (GaN) or a gallium arsenide substrate (GaAs). Moreover, reference to transistor features such as gate, source, or drain is not intended to exclude any suitable transistor technologies. For instance, features such as source, drain, and gate are typically used to refer to a FET, while emitter, collector, and base are typically used to refer to a BJT. Such features may be used interchangeably herein. For instance, reference to the gate of a transistor may refer to either the gate of a FET or the base of a BJT, and vice-versa. In some examples, a control terminal may refer to either the gate of a FET or the base of a BJT. Any other suitable transistor technologies can be used. Any such transistors can be used as a switch, with the gate or base or other comparable feature acting as a switch select input that can be driven to connect the source and drain (or the emitter and collector, as the case may be).

References herein to a field effect transistor (FET) being “ON” (or a switch being closed) means that the conduction channel of the FET is present, and drain current may flow through the FET. References herein to a FET being “OFF” (or a switch being open) means that the conduction channel is not present, and drain current does not flow through the FET. A FET that is OFF, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−11 percent of that parameter.

Modifications are possible in the described examples, and other examples are possible within the scope of the claims.

1. A power controller, comprising:
a control loop configured to control timing of pulsed signals that activate phases of a coupled inductor voltage regulator based on current demand of a load circuit;
a transient detection circuit configured to determine a projected current through a compensation inductor of the coupled inductor voltage regulator based on a state of the phases and operating parameters of the coupled inductor voltage regulator;
wherein the transient detection circuit is configured to detect a transient in the current demand of the load circuit based on a variability in phase-to-phase overlap of the pulsed signals; and
wherein, responsive to detecting the transient, the transient detection circuit is configured to apply a correction to the control loop that alters the timing of the pulsed signals based on the projected current through the compensation inductor.

2. The power controller of claim 1, wherein:
the transient detection circuit is configured to enable the correction to the control loop based on the variability in the overlap indicating an increase in the overlap exceeding a first threshold, and disable the correction to the control loop based on the variability in the overlap indicating a decrease below a second threshold after exceeding the first threshold.

3. The power controller of claim 1, wherein:
the transient detection circuit is configured to enable the correction to the control loop based on the variability in the overlap indicating a decrease in the overlap falling below a first threshold, and disable the correction to the control loop based on the variability in the overlap indicating an increase above a second threshold after falling below the first threshold.

4. The power controller of claim 1, wherein the correction to the control loop comprises one or more among a first correction to an AC portion of the control loop and a second correction to a DC portion of the control loop.

5. The power controller of claim 1, wherein the transient detection circuit is configured to:
determine the operating parameters of the coupled inductor voltage regulator based at least on an inductance of the compensation inductor; and
determine the state of the phases based at least on a quantity of the phases present and a state of activation of the phases.

6. The power controller of claim 1, wherein the correction to the control loop comprises scaled combined rates of change of projected currents supplied by each phase determined based at least in part on the operating parameters and the projected current through the compensation inductor.

7. The power controller of claim 1, wherein the correction to the control loop comprises a load current adjustment for the control loop corresponding to a difference between reported current demand for the load circuit and a scaled version of the projected current through the compensation inductor.

8. The power controller of claim 1, comprising:
a set of programmable registers defining at least an entry threshold and an exit threshold for the transient.

9. A method, comprising:
determining, by a control loop, a timing of pulsed signals that activate phases of a coupled inductor voltage regulator based on current demand of a load circuit;
determining, by a transient detection circuit, a projected current through a compensation inductor of the coupled inductor voltage regulator based on a state of the phases and operating parameters of the coupled inductor voltage regulator;
monitoring, in the transient detection circuit, variability in phase-to-phase overlap of the pulsed signals to detect a transient condition in the current demand of the load circuit; and
during at least a portion of the transient condition, applying, by the transient detection circuit, a correction to the control loop that alters the timing of the pulsed signals based on the projected current through the compensation inductor.

10. The method of claim 9, further comprising:
enabling, by the transient detection circuit, the correction to the control loop based on the variability in the overlap indicating an increase in the overlap exceeding a first threshold; and
disabling the correction to the control loop based on the variability in the overlap indicating a decrease below a second threshold after exceeding the first threshold.

11. The method of claim 9, further comprising:
enabling, by the transient detection circuit, the correction to the control loop based on the variability in the overlap indicating a decrease in the overlap falling below a first threshold; and
disabling the correction to the control loop based on the variability in the overlap indicating an increase above a second threshold after falling below the first threshold.

12. The method of claim 9, wherein the correction to the control loop comprises one or more among a first correction to an AC portion of the control loop and a second correction to a DC portion of the control loop.

13. The method of claim 9, further comprising:
determining, by the transient detection circuit, the operating parameters of the coupled inductor voltage regulator based at least on an inductance of the compensation inductor and a voltage across the compensation inductor; and
determining, by the transient detection circuit, the state of the phases based at least on a quantity of the phases present and a state of activation of the phases.

14. The method of claim 9, wherein the correction to the control loop comprises scaled combined rates of change of projected currents supplied by each phase determined based at least in part on the operating parameters and the projected current through the compensation inductor.

15. The method of claim 9, wherein the correction to the control loop comprises a load current adjustment for the control loop corresponding to a difference between reported current demand for the load circuit and a scaled version of the projected current through the compensation inductor.

16. The method of claim 9, further comprising:
providing, by the transient detection circuit, a set of programmable registers defining at least an entry threshold and an exit threshold for the transient condition.

17. An apparatus, comprising:
one or more computer readable storage media;
program instructions stored on the one or more computer readable storage media, the program instructions executable by a processing system to direct the processing system to at least:
determine a projected current through a compensation inductor of a coupled inductor voltage regulator based on a state of phases of the coupled inductor voltage regulator and operating parameters of the coupled inductor voltage regulator;
detect a transient in current demand of a load circuit supplied by the coupled inductor voltage regulator based on a variability in phase-to-phase overlap of pulsed signals; and
responsive to detecting the transient, apply a correction to a control loop that alters a timing of the pulsed signals based on the projected current through the compensation inductor.

18. The apparatus of claim 17, comprising further instructions executable by the processing system to direct the processing system to at least:
enable the correction to the control loop based on the variability in the overlap indicating an increase in the overlap exceeding a first threshold or a decrease in the overlap falling below a second threshold; and
disable the correction to the control loop based on the variability in the overlap indicating a decrease below a third threshold after exceeding the first threshold or an increase above a fourth threshold after falling below the second threshold.

19. The apparatus of claim 17, comprising further instructions executable by the processing system to direct the processing system to at least:
determine the operating parameters of the coupled inductor voltage regulator based at least on an inductance of the compensation inductor and a voltage across the compensation inductor; and
determine the state of the phases based at least on a quantity of the phases present and a state of activation of the phases.

20. The apparatus of claim 17, wherein the correction to the control loop comprises a load current adjustment for the control loop corresponding to a difference between reported current demand for the load circuit and a scaled version of the projected current through the compensation inductor.
